(19) United States
(12) Patent Application Publication
(10) Pub. No.: US 2011/0304165 A1
(43) Pub. Date: Dec. 15, 2011

(54) Door Rod and Clip Assembly

(75) Inventor: Richard K. Mette, Shelby Township, MI (US)

(73) Assignee: GM GLOBAL TECHNOLOGY OPERATIONS, INC., Detroit, MI (US)

(21) Appl. No.: 12/814,799

(22) Filed: Jun. 14, 2010

(51) Int. Cl. E05B 3/00

(52) U.S. Cl. 292/336.3

(57) ABSTRACT

A door rod and clip assembly for use with a door inner panel of a vehicle door comprising a lock rod and a rod clip. The rod has a first portion attached to a latch assembly and a second portion including a finger pull. The clip is formed of an elastomeric material and includes a retention member that secures the rod clip to the door inner panel, a base portion mounted adjacent to the door inner panel, a pair of support arms extending from the base and defining a receiving slot, and flexible ribs extending from the support arms to define a flexibility slot aligned with the receiving slot. The ribs include corresponding rod retention cutouts that retain the lock rod in a predetermined orientation, whereby the predetermined orientation of the lock rod positions the lock rod for assembly of an interior door trim panel.

### BACKGROUND OF INVENTION

The present invention relates generally to vehicle doors and more particularly to rod and clip assemblies mounted to vehicle doors.

Side doors in automotive vehicles typically have a lock rod that extends from a vehicle latch/lock assembly to a finger pull that is accessible to a vehicle occupant. In these doors, a common configuration is one where the lock rod passes through a door inner panel, with a grommet that somewhat supports the lock rod and also seals the hole in the inner panel through which the lock rod passes. This support helps maintain the lock rod in a position that will ease assembly of an interior trim panel to the door and may also help to avoid potential lock rod rattling problems when the door is closed. Rod rattling sounds emanating from the door bother some vehicle occupants and so can lead to warranty concerns.

### SUMMARY OF INVENTION

An embodiment contemplates a door rod and clip assembly for use with a door inner panel of a vehicle door comprising a lock rod and a rod clip. The lock rod has a first portion attached to a door latch assembly and a second portion including a finger pull accessible by a vehicle occupant. The rod clip is formed of an elastomeric material and includes a retention member that secures the rod clip to the door inner panel, a base portion mounted adjacent to the door inner panel, a pair of support arms extending from the base away from the door inner panel and having ends that define a receiving slot, and a plurality of flexible ribs extending from the support arms to define a flexibility slot aligned with the receiving slot. The flexible ribs include corresponding rod retention cutouts that receive and retain the lock rod in a predetermined orientation, whereby the predetermined orientation of the lock rod positions the lock rod for assembly of an interior door trim panel to the door inner panel.

An advantage of an embodiment is, for a lock rod that does not pass through a door inner panel and so does not have a rod pass through grommet, the rod is held in place by the soft rod clip to assist in assembly of an interior trim panel to the door, while avoiding potential binding and rattling concerns. Moreover, the soft rod clip is configured to mount to the door inner panel while sealing the hole in which it mounts, and while maintaining the proper orientation to hold the lock rod in place.

### BRIEF DESCRIPTION OF DRAWINGS

FIG. 1 is a perspective view of a portion of a vehicle door and a rod and clip assembly.

FIG. 2 is another perspective view of a portion of the vehicle door and the rod and clip assembly.

FIG. 3 is an elevation view of a portion of the vehicle door.

FIG. 4 is a perspective view of a portion of the rod and clip assembly according to another embodiment.

FIG. 5 is a partial cross section, plan view of a portion of the rod and clip assembly according to the embodiment of FIG. 4.

### DETAILED DESCRIPTION

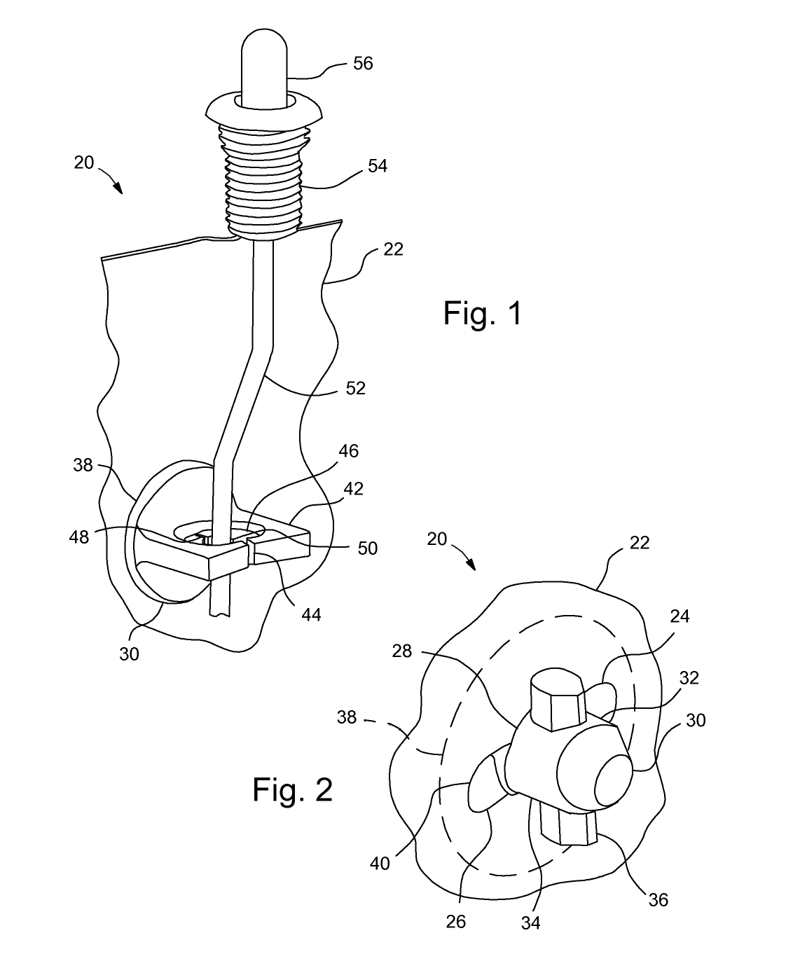

Referring to FIGS. 1-3, a portion of vehicle door, indicated generally at 20, is shown. The vehicle door 20 includes a door inner panel 22. The door inner panel is typically a metal panel that is located between a door outer panel (not shown, forming the exterior surface of the door 20) and an interior door trim panel (not shown, forming the interior surface of the door that is exposed to the vehicle occupants). The door outer panel and interior door trim panel can be conventional. The door inner panel 22 includes a key hole 24 that is shaped as an elongated oval 26 having a central circular cutout portion 28 (best seen in FIG. 3). The key hole 24 is configured to receive a soft rod clip 30.

The rod clip 30 includes a retention member 32 that extends through the key hole 24. The retention member 32 has a base portion 34 that is generally cylindrical and is sized to slide through the circular cutout portion 28. A pair of retention flanges 36 extend from the base portion 34 and are sized and shaped to allow the flanges 36 to slide through the elongated oval 26. In this way, the retention member 32 can be slid through the key hole 24 with the retention flanges 36 aligned with the elongated oval 26 and then rotated so that the retention flanges 36 are secured against the door inner panel 22 (as best seen in FIG. 2).

The rod clip 30 also includes a clip base 38 that is secured against the door inner panel 22. The clip base 38 may include sealing and orientation protrusions 40 that are shaped and oriented to fit within the elongated oval 26 when the rod clip 30 is installed at the proper orientation. Thus, the clip base 38 seals the door inner panel 22 at the key hole 24 to prevent moisture from passing through the key hole 24.

The rod clip 30 also includes a pair of support arms 42 that extend outward from the clip base 38 and toward each other to define a receiving slot 44. The support arms 42 may have ramped surfaces on both sides of the receiving slot 44 in order to better guide a lock rod, discussed below, into the slot. Extending from each support arm 42 is a pair of thin flexible ribs 46. The edges of the flexible ribs 46 align with the receiving slot 44 to form a flexibility slot 48 and include a pair of corresponding semicircular rod retention cutouts 50.

A lock rod 52 extends through the rod retention cutouts 50. The diameter of the lock rod 52 is greater than the width of the receiving slot 44 and the flexibility slot 48. The rod retention cutouts 50 may be sized to provide a touch condition where the cutouts 50 form an opening about equal to the diameter of the rod 52, which may allow the flexible ribs 46 to dampen vibrations of the rod 52 under various vehicle operating conditions. Alternatively, the cutouts 50 may be sized to form an opening slightly larger than the diameter of the rod 52 so that the rod 52 does not touch the ribs 46 after installation of an interior door trim panel.

The rod clip 30 may be made of ethylene propylene diene monomer (EPDM), an elastomer sometimes referred to as a synthetic rubber. More specifically, a type of EPDM that may be employed is SAE J200 M4CA610 A25 B35 C32 F17 G21 Z1 Z1=WAX BLOOM or equivalent. This material is relatively soft and slippery, giving the rod clip 30 the ability to hold the rod 52 in a vertical position during assembly of the interior door trim panel while minimizing the potential for the rod clip 30 to cause binding of the lock rod 52 during use.

The lock rod 52 may be assembled by attaching a bottom end (not shown) to a latch assembly (not shown), which may be conventional, and sliding the lock rod 52 through the receiving slot 44 and the flexibility slot 48 until it is retained in the rod retention cutouts 50. The rod retention cutouts 50 are positioned such that the rod 52 will be retained in (or close to) its desired position for installation of the interior door trim panel. The support arms 42 are more stiff than the flexible ribs 46 to assure that during the process of installing the interior door trim panel, the rod 52 can move somewhat by flexing the ribs 46 in order to ease assembly, but the rod 52 will not be pulled completely out of position through the receiving slot 44. The ribs 46 may be, for example, about one millimeter thick to provide the needed support during installation of the trim but not interfere with operation of the lock rod 52.

The lock rod 52 may include a lock rod trim member 54 near its upper end that mounts to a hole in the interior door trim panel, with a finger pull 56 extending upward from there. The finger pull 56 is accessible to vehicle occupants. Preferably, the rod clip 30 is mounted on the door inner panel 22 relatively close to the trim member 54, which may increase the ease with which the door trim panel is installed.

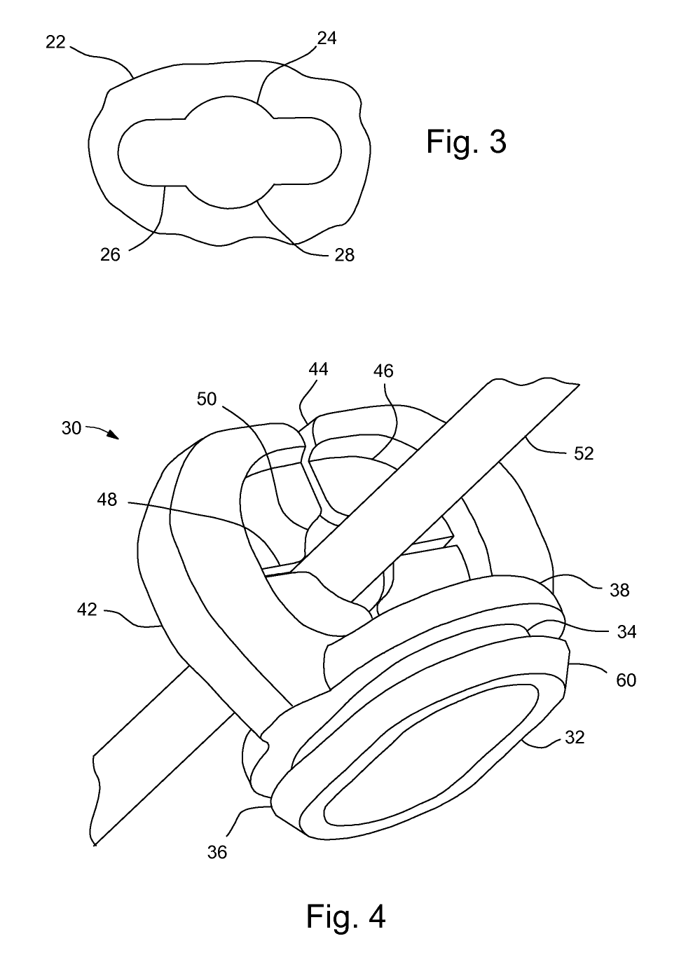

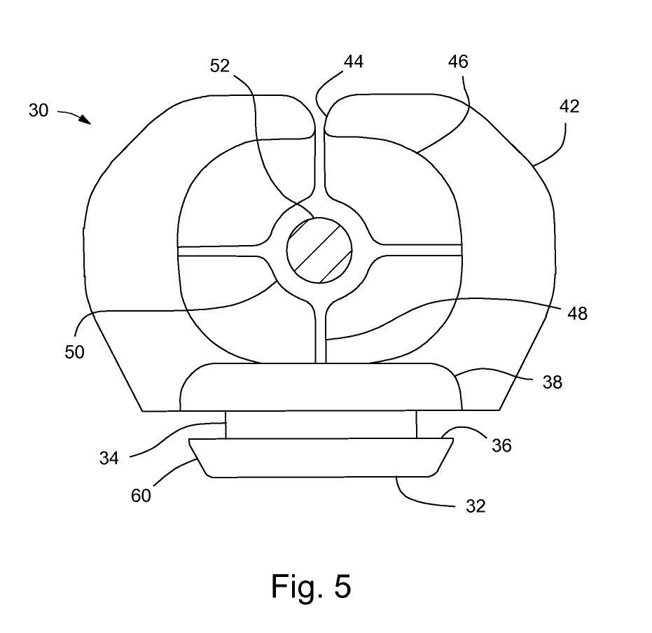

FIGS. 4 and 5 illustrate another embodiment of the rod clip 30. In this embodiment, the retention member 32, clip base 38, support arms 42 and flexible ribs 46 are shaped somewhat different than in the first embodiment.

The retention member 32 has an oval shaped base portion 34 that extends through an oval shaped hole in the door inner panel (not shown in this embodiment). A retention flange 36 extends from the base portion 34 and is also generally oval shaped. The oval, as opposed to round, shape assures the proper orientation of the rod clip 30 relative to the door inner panel. The retention flange 36 has a tapered outer periphery 60, allowing for relatively easy installation of the clip 30 while providing for good retention once in the hole.

The support arms 42, while somewhat more rounded than the first embodiment, still extend from the clip base 38 and define a receiving slot 44 through which the lock rod 52 can be installed. This embodiment includes four flexible ribs 46 extending from the support arms 42 to define two flexibility slots 48. This additional slot 48 may provide for additional flexibility when assembling the interior door trim panel to the door. Each of the flexible ribs 46 still includes rod retention cutouts 50 that create a hole for receiving the lock rod 52. In this embodiment, the retention cutouts 50 are large enough to create clearance between the ribs 46 and the lock rod 52 once the interior door trim panel has been installed. This assures no binding will occur between the rod 52 and ribs 46 during operation of the lock rod. Alternatively, the rod retention cutouts 50 may be smaller so that some contact between the rod 52 and ribs 46 occurs after installation in order to assist in reducing vibration of the lock rod 52 during vehicle operation.

The material of the rod clip 30 may be the same as in the first embodiment, and the installation procedure may also be the same and thus will not be discussed relative to this embodiment.

While certain embodiments of the present invention have been described in detail, those familiar with the art to which this invention relates will recognize various alternative designs and embodiments for practicing the invention as defined by the following claims.

What is claimed is:

1. A door rod and clip assembly for use with a door inner panel of a vehicle door, the assembly comprising:
a lock rod configured to have a first portion attached to a door latch assembly and a second portion including a finger pull accessible by a vehicle occupant; and
a rod clip formed of an elastomeric material including a retention member configured to secure the rod clip to the door inner panel, a base portion configured to be mounted adjacent to the door inner panel, a pair of support arms extending from the base away from the door inner panel and having ends that define a receiving slot, and a plurality of flexible ribs extending from the support arms to define a flexibility slot aligned with the receiving slot, the flexible ribs including corresponding rod retention cutouts that receive and retain the lock rod in a predetermined orientation, whereby the predetermined orientation of the lock rod positions the lock rod for assembly of an interior door trim panel to the door inner panel.

2. The door rod and clip assembly of claim 1 wherein the rod clip includes a second flexibility slot oriented generally normal to the flexibility slot.

3. The door rod and clip assembly of claim 1 wherein the retention cutouts define a pass-through having a diameter approximately equal to a diameter of the lock rod.

4. The door rod and clip assembly of claim 1 wherein the retention cutouts define a pass-through having a diameter larger than a diameter or the lock rod.

5. The door rod and clip assembly of claim 1 wherein the flexible ribs have a thickness substantially less than a thickness of the support arms.

6. The door rod and clip assembly of claim 1 wherein the receiving slot has a width that is less than a diameter of the lock rod.

7. The door rod and clip assembly of claim 1 wherein the rod clip is made of ethylene propylene diene monomer.

8. The door rod and clip assembly of claim 1 wherein the retention member includes a cylindrical base that is configured to extend through a circular cutout portion of a keyhole through the door inner panel, and a retention flange extending radially from the cylindrical base and configured to slide through an elongated oval portion of the keyhole, whereby rotation of the rod clip after insertion of the retention member into the key hole will retain the rod clip to the door inner panel.

9. The door rod and clip assembly of claim 1 wherein the retention member includes an oval base that is configured to extend through an oval shaped hole through the door inner panel, and an oval shaped retention flange extending radially from the oval base and configured to be compressible to slide through the oval shaped hole and spring back, whereby the retention flange will retain the rod clip to the door inner panel.
